(19) United States
(12) Patent Application Publication
(10) Pub. No.: US 2004/0070203 A1
(43) Pub. Date: Apr. 15, 2004

(54) Device for holding a hose

(76) Inventor: Stefan Karlinger, Augsburg (DE)

Correspondence Address: MCGLEW & TUTTLE, PC, 1 SCARBOROUGH STATION PLAZA, SCARBOROUGH, NY, 10510-0827, US

(21) Appl. No.: 10/664,716

(22) Filed: Sep. 18, 2003

(30) Foreign Application Priority Data
Sep. 21, 2002 (DE) 102 44 027.1

(51) Int. Cl. F16L 27/00

(52) U.S. Cl. 285/189; 285/903; 285/251

(57) ABSTRACT

In order to protect an angular movable or sidewards bendable hose, such as e.g. a protective hose for supply lines or cables, on a machine or robot against bending and therefore premature wear, in the case of a device (1) for holding such a hose (2), the invention provides at least one holding area (3) for the at least axial holding of the hose (2) and with at least one one-sided support area (4) surrounding the hose (2) and extending towards the free end (4.2).

### FIELD OF THE INVENTION

The invention relates to a device for holding a flexible hose.

### BACKGROUND OF THE INVENTION

Machines and in particular industrial robots have flexible protective hoses through which are passed supply lines, cables, etc., known overall as hose sets, for devices on the machine or robot and in particular the tool fitted to a robot hand and which are to be held together and protected by the protective hose. The flexible hose can in part be exposed to extreme lateral and bending aside movements, e.g. if the supply lines or cables terminating at the tool (on the hand) are exposed by the tool movement to different types of relative movements which have to be followed by the hose surrounding them. If the hose end remote from the tool-side end of the supply lines and cables is secured at a fixed point of the machine or robot, the lateral or bending movements of the protective hose can lead to fatigue and finally to breaking and damage to the protective hose. To reduce this risk, for holding the protective hose on the tool-remote end are provided spherical joints. The latter only have a limited mobility range and in the case of being relieved (in the axial direction) can stress other elements of the hose sets. They are also complicated and expensive.

The problem of the invention is therefore to provide a simply designed, inexpensive relief aid for a flexible hose, which in the case of relatively high mobility and therefore permitting a narrow bending radius, still ensures a good support of a flexible hose in the case of lateral movement or bending aside and in this way reduces wear stresses on the hose without excessively stressing further hose set components.

### SUMMARY OF THE INVENTION

According to the invention this problem is solved with a device for holding a hose of the aforementioned type, which has at least one holding area for at least axially holding the hose and at least one one-sided support area surrounding the hose and extending towards the free end.

Due to the fact that the device according to the invention at least axially holding the hose has on at least one side a support area with a preferably trumpet-shaped widening, in the case of lateral or bending aside movements the hose is supported and therefore relieved and can consequently not kink in this area. If rotation simultaneously occurs, the protective hose rolls on the circumference of the radius and no friction, i.e. wear occurs, because the rotary movement takes place between the clamping member and the spherical bush. The radius R1 of the widening or extension, at least in the inner area thereof, is of the same order of magnitude as the minimum bending radius of the hose to be received, minus half the diameter of the hose. The minimum bending radius of a hose can generally be gathered from the hose manufacturer's table. Alternatively determination is also possible by location tests.

In order to ensure an edgeless transition of the device according to the invention at the free ends of the extension, the latter is provided immediately upstream of its front end or at the same with a radius R2 which is smaller than the radius R1 and which is preferably 10 to 20% of the radius of the inner extension area. Between a first rib for holding a ribbed hose and the inner extension area a cylindrical section is preferably provided. The transitions from the cylindrical section to the inner extension area of radius R1 and from there to the rounding with radius R2 in the vicinity of the front end are in each case tangential and therefore continuous.

Since, as a rule, such flexible protective hoses are constructed as ribbed hoses, according to a preferred development of the invention, the holding area has inwardly directed annular ribs. This achieves in the axial direction a positive retention of the protective hose in the device according to the invention whilst, if desired, through corresponding dimensioning a frictional grip can be brought about between the inventive device and the hose to prevent twisting. According to another preferred development, an application area for applying the device to a holding part is provided, said holding part preferably being constructed as a clamp or clip. For the connection between the device according to the invention and the holding part, the invention also provides for the application area to have an outer annular groove, inwardly directed lugs of the holding part or the clamp engaging in said annular groove, so that also here an axially positive connection is ensured between the holding part/clamp and the device according to the invention.

So that more particularly in the case of a positive connection of a holding device according to the invention and the hose, particularly a ribbed hose, said device can be mounted on the hose, according to a further development of the invention there is a construction comprising at least two partial shells (half-shells). The individual partial or half-shells of the inventive device can be radially held together in different, per se known ways, e.g. by screwing or by snap connections on their front faces. In a preferred development the partial shells can be held together by a closing ring, which can be constructed in one piece and can then be axially engaged on a cylindrical holding section of the device according to the invention. Alternatively the closing ring can have a multipart construction and on its front faces are formed connecting devices. The latter can once again be formed by snap connection devices, so that the closing ring is closed by radially moving together the individual parts (partial rings). In a highly preferred development, the partial rings of the closing ring are interconnectable by snap constructions by snapping in at right angles to the axis of symmetry. In the closed position there are back-engaging, complimentary shapes on the front faces of the partial rings of the closing ring with axial connectability of the shapes and therefore the partial rings. Such a closing ring is disclosed in the parallel patent application entitled “Closing ring”, which also covers preferred developments of the present invention and whose disclosure is therefore made fully into part of the content of this patent application and whose documents are enclosed with the present application for disclosure purposes as enclosure I.

According to a preferred development, in the vicinity of the partial shells of the device according to the invention, are provided self closures e.g. in the form of pins engaging in holes or webs engaging in grooves.

Thus, according to the invention, a device for holding a hose is provided, which protects the latter against damage, in that accompanied by axial retention on bending aside the hose the latter engages on the inner radius of the extension of the support area and consequently is supported and relieved by the same.

### BRIEF DESCRIPTION OF THE DRAWINGS

Further advantages and features of the invention can be gathered from the following description of embodiments of the invention with reference to the attached drawings, wherein show:

FIG. 1 A first embodiment of a device according to the invention for holding together a ribbed hose with a clamp or clip holding the latter and also the device, in section.

FIG. 2 A larger scale sectional representation of the device for holding the ribbed hose according to FIG. 1, also in section.

FIG. 3 A perspective sectional representation of the embodiment of the device for holding a ribbed hose according to FIGS. 1 and 2.

FIG. 4 A perspective representation of the embodiment of the device for holding a ribbed hose according to FIGS. 1 to 3 with a closing ring radially holding the device.

FIG. 5 A view of the holding device according to the invention viewing the front face of a half-shell.

FIG. 6 A perspective representation corresponding to FIG. 4 of the further embodiment of the inventive device for holding a ribbed hose according to FIG. 5.

FIG. 7 A side view of a further embodiment of the device according to the invention.

### DETAILED DESCRIPTION OF THE DRAWINGS

The device 1 according to the invention is used in the embodiment shown for holding or retaining a ribbed hose 2. Such a ribbed hose 2 is provided at least on its outside with ribs 2.1 between which are formed annular grooves 2.2.

For axially holding the ribbed hose 2, the device 1 according to the invention has an inner holding area 3, on which are constructed inwardly projecting annular ribs 3.1. In the embodiment shown there are two annular ribs. However, it is also possible to have a single annular rib or more than two annular ribs. The annular ribs 3.1 are directed into the annular grooves 2.2 of the ribbed hose 2 and consequently hold the same firmly and axially together.

A friction grip is able to prevent twisting. In the representation of the drawings, the ribbed hose 2, at least to the right, projects out of the device 1.

In order to support the ribbed hose 2 during a bending away as a result of the movement of its free end remote from the device 1, onto the holding area 3 in the direction of the region of the ribbed hose 2 projecting out of the device 1 is connected a support area 4 of the inventive device 1, i.e. in the drawings considered to the right from the holding area 3.

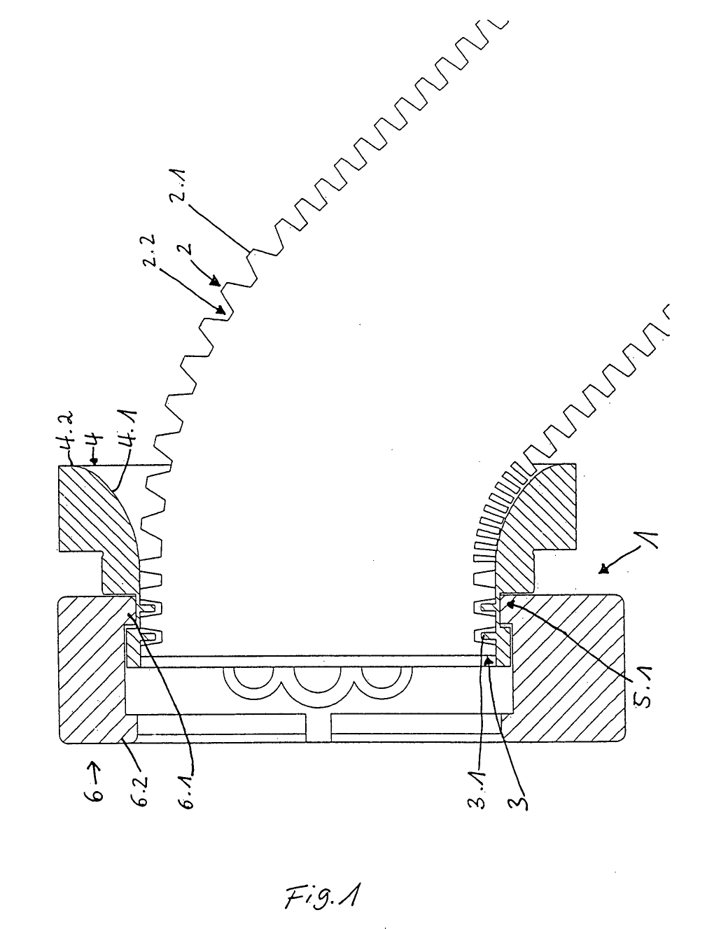

A lateral or bending away movement of the ribbed hose 2, as shown in FIG. 1, can e.g. occur if the ribbed hose 2 is used as a protective hose for supply lines or cables of motors or a tool on a robot hand, whereby the latter can perform numerous different movements (generally about three axes), which the supply lines or cables and therefore also the free end of the ribbed hose 2 must follow.

The support area 4 of the inventive device 1 has a trumpet-shaped widening or extension 4.1. Therefore the extension 4.1 is continuous, uniform and optionally constructed with a radius of curvature progressively decreasing from the holding area 3 at the free end 4.2 of the support area 4.

The device 1 according to the invention is also constructed with an application area 5 by means of which it can be applied and fixed to a robot part. The application area 5 is directed through an outer annular groove 5.1, which engages in an inner annular projection 6.1 of a fixing clamp or clip 6 and in this way secures axially on a machine, robot or the like said device 1 and also the ribbed hose 2 and to which is fixed the clamp 6. Preferably the holding of the device 1 in clamp 6 takes place in rotary manner, so that during rotary movements of the ribbed hose 2, the device 1 can also rotate in the clamp 6.

The clamp 6 may have a further inner annular lug 6.2 by means of which an end piece of a further ribbed hose or the like can be secured. In the embodiment of FIGS. 1 to 4 the application area 5 is essentially at the same height of centre, radially outside the inner holding area 3, but an axial displacement can exist between areas 3 and 5.

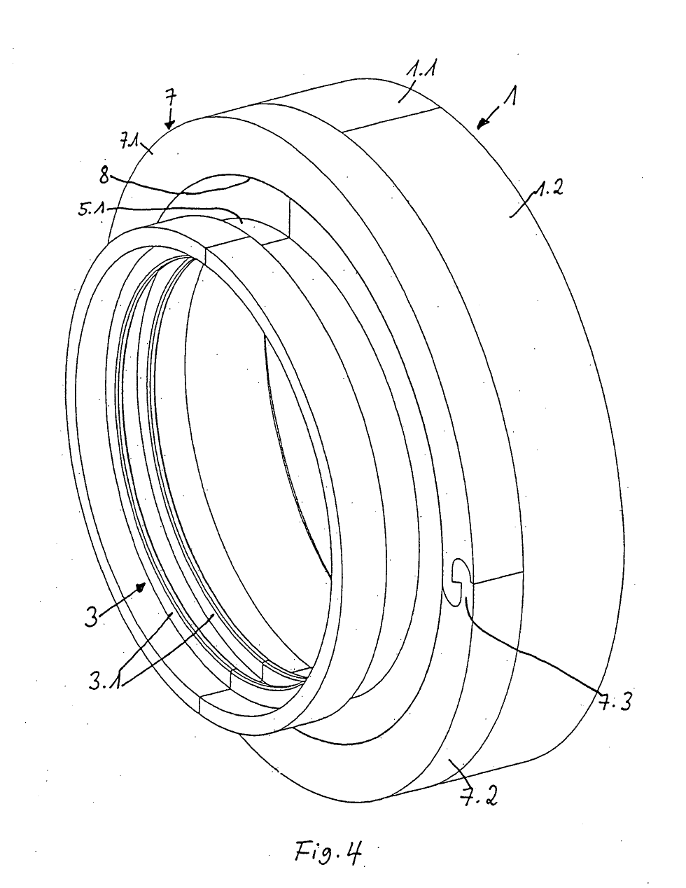

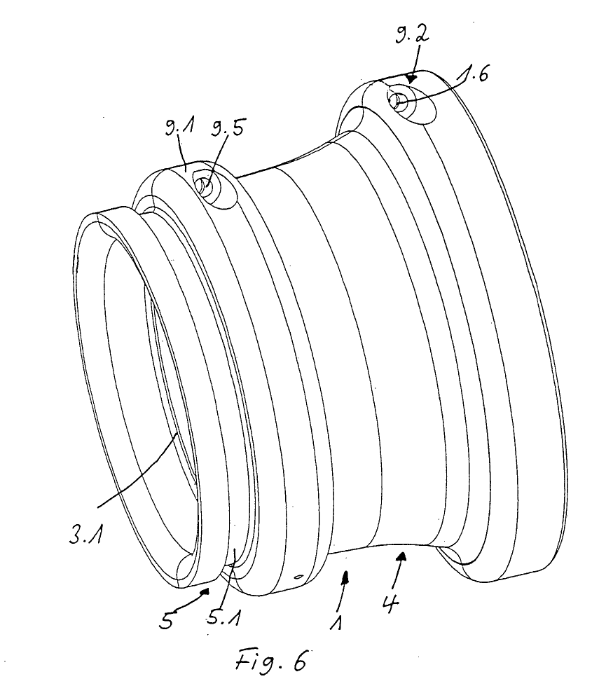

The application area 5, holding area 3 and support area 4 are constructed in one piece, but the entire device is circumferentially split, i.e. formed from several parts, preferably having two partial shells (half-shells), as can be more particularly gathered from FIGS. 4 and 6.

The two half-shells can then be held together in per se known manner, e.g. by screws (as shown in FIG. 6), by circumferentially acting snap closures, which either are constructed in the half-shells or on an additional closing ring.

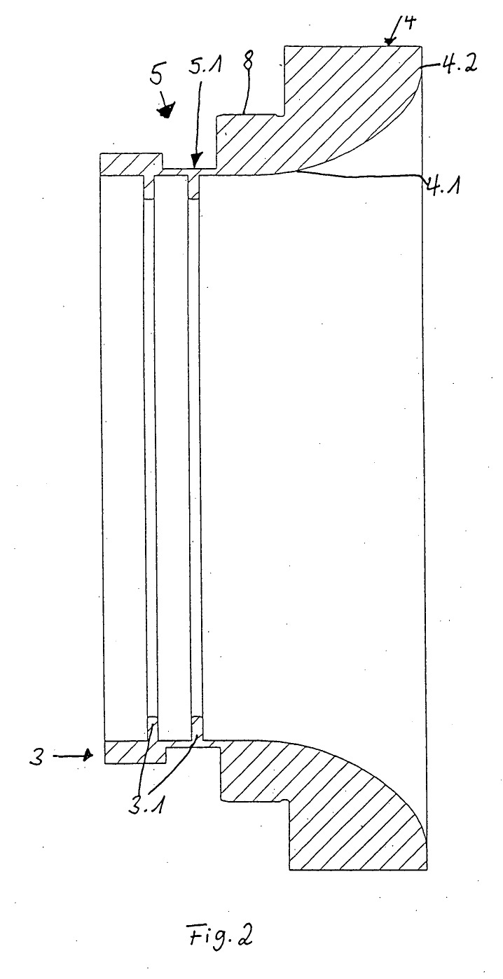

FIG. 4 shows another possibility for holding together the half-shells 1.1, 1.2 of the inventive device 1, namely by a closing ring 7, comprising two half-rings 7.1 and 7.2, which have on their front faces circumferentially acting, mutually complimentary, relatively rigid or solid shapes 7.3, by means of which the closing ring 7 is closed and therefore the device 1 comprising the two half-shells 1.1 and 1.2 is held together. The closing ring 7 is located on an annular shoulder 8 of device 1 (cf. also FIG. 2), preferably in frictionally gripping manner. The connection of the two half-rings 7.1 and 7.2 of the closing ring 7 takes place in that the shapes 7.3 are axially interengaged. For further details reference is made to enclosure I.

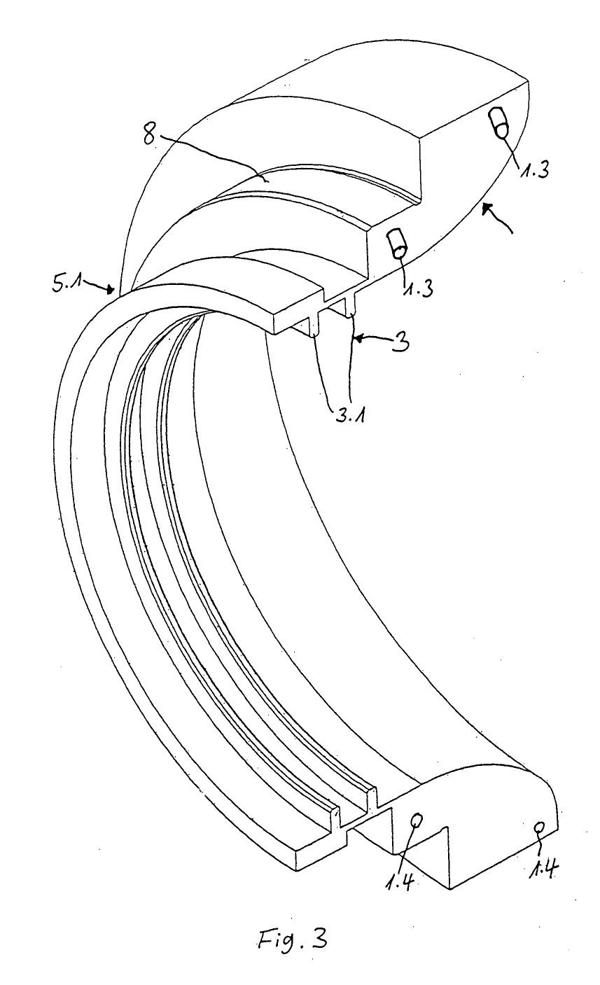

As shown in FIG. 3, the half-shells 1.1, 1.2 of the inventive device have, for preventing an axial relative movement between them, shapes which are constructed in the representation of FIG. 3 as pins 1.3 and holes 1.4. Ribs 2.1 and grooves 2.2 can be provided at the contact areas of the half-shells 1.1, 1.2.

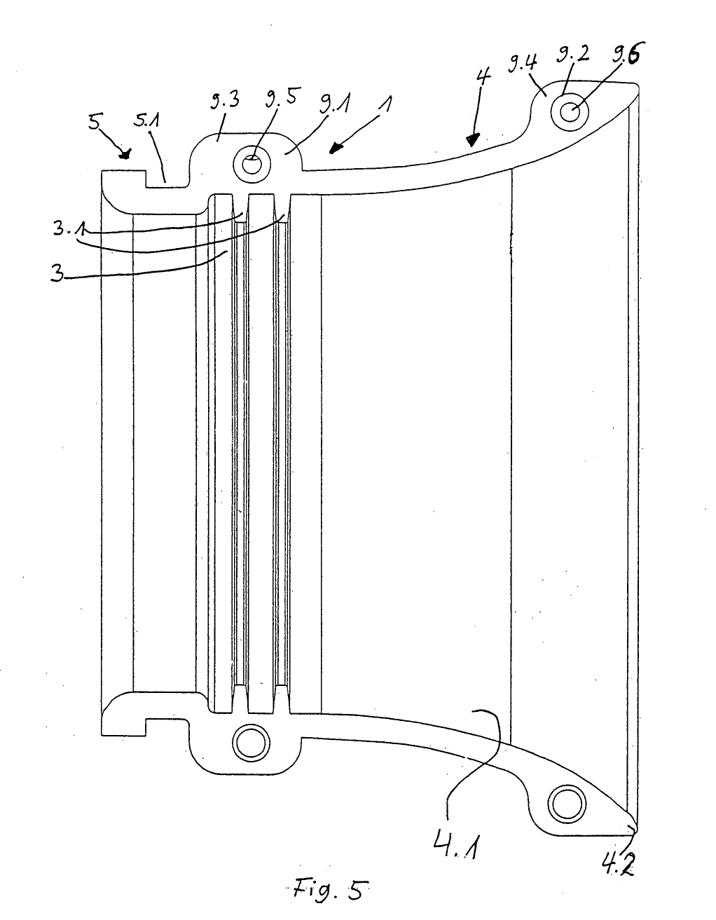

FIGS. 5 and 6 show a somewhat modified construction of the device according to the invention for holding a ribbed hose. To the extent that the same parts are present, they are given the same reference numerals and for the description thereof reference is made to the description of the development of FIGS. 1 to 5, so that hereinafter essentially only the differing details will be described.

In FIG. 5 the device 1 according to the invention also has a holding area 3 for a ribbed hose 2, said holding area 3 also having two inwardly projecting annular grooves 3.1. On one side a support area 4 is connected, but an inventive device can also have two support areas extending from either side of the holding section 3 and widening from the inside to the outside.

There is also an application area 5 with an annular groove 5.1, which in the development of FIGS. 5 and 6 is axially displaced relative to the inner holding area 3, namely in the opposite direction to support area 4.

The variants of FIGS. 5 and 6 also having fixing structures 9.1 and 9.2, which are essentially formed by openings 9.5, 9.6 constructed in an outer torus 9.3, 9.4 close to the separating face of the half-shells 1.1, 1.2 of the inventive device 1 and through which can be passed screws for holding together the half-shells 1.1 and 1.2 of the inventive device 1, which either in the case of a corresponding construction of one of the openings can be fixed in in each case one half-shell by cutting the screw thread into the plastic material of device 1 or also by a nut connectable to the screw and provided on the opposite side.

A further difference of the variant of FIGS. 5 and 6 is that the support area 4 is more elongated than in the case of FIGS. 1 to 4 and the curvature conditions are fundamentally greater with the radius of curvature decreasing progressively from area 3 to the free front face and which therefore as from the curvature of the trumpet-like widening area is not as pronounced as in the variant of FIGS. 1 to 4.

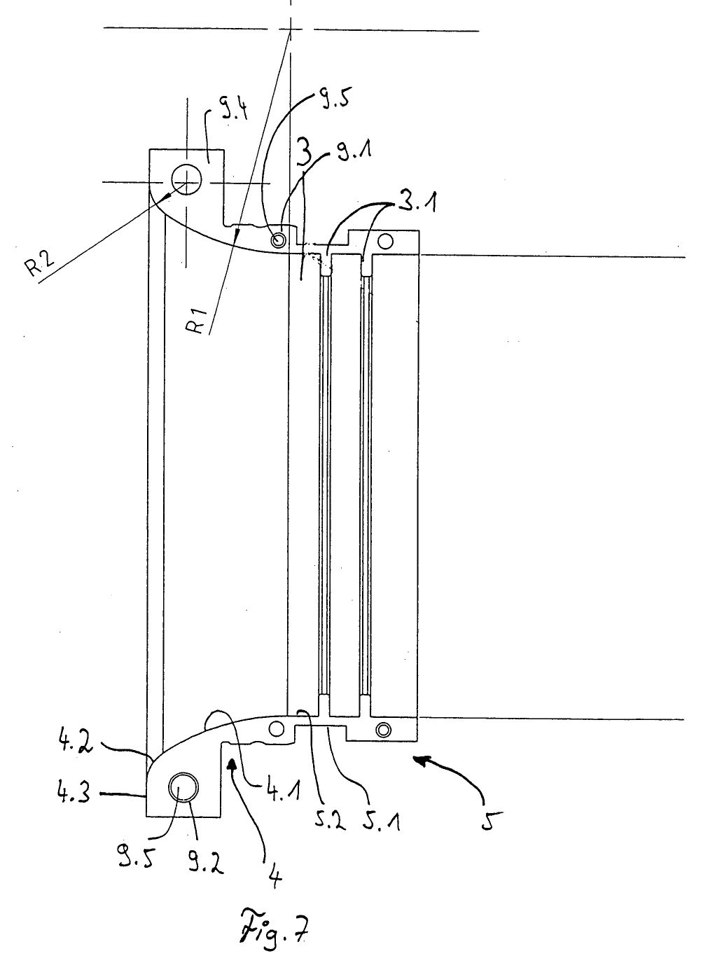

FIG. 7 shows a further longitudinal section through a device according to the invention similar to FIG. 5. What is stated hereinafter concerning FIG. 7 also applies for further developments of inventive devices. To the rib 3.1 is firstly connected towards the trumpet-like extension 4.1 a cylindrical area 5.2, whose diameter essentially corresponds to the external diameter of the ribbed hose. On the latter runs the inner extension area 4.1, where the radius of curvature of extension R1 corresponds to the minimum bending radius of the hose, minus half the diameter of the hose to be received. The minimum bending radius of the hose is generally given by the hose manufacturer, but can alternatively be determined by tests. To the inner extension area 4.1 is connected towards the front face of the inventive device a rounding 4.2 in the front face area having a radius R2. Radius R2 is between 10 and 20% of radius R1. This creates an edgeless transition to the planar front face 4.3 of the device.

The transitions between the cylindrical section 4.5 and the extension or support area 4.1 and between the latter and the outer rounding are in each case tangential and therefore continuous.

The subject matter of the invention is all that is shown in the drawings and all that is described hereinbefore with respect to the inventive device for holding a ribbed hose as such, particularly with its holding and support area, but also with its application area. The subject matter of the preferred development of the invention also includes the closing ring according to enclosure I cooperating with the inventive device for holding the ribbed hose, together with the application area of the inventive device in conjunction with the clamp and consequently the latter in conjunction with the inventive device.

### LIST OF REFERENCE NUMERALS

1 Device

1.1, 1.2 Half-shells

1.3 Pins

1.4 Holes

2 Ribbed hose

2.1 Ribs

2.2 Grooves

3 Holding area

3.1 Annular ribs

4 Support area

4.1 Trumpet-shaped extension

4.2 Free end

5 Application area

5.1 Outer annular groove

6 Fixing clamp or clip

6.1 Inner annular projection

6.2 Annular lug

7 Closing ring

7.1, 7.2 Holding rings

7.3 Shapes

8 Annular shoulder

9.1, 9.2 Fixing constructions

9.3, 9.4 Outer torus

9.5, 9.6 Openings

1. Device for holding a flexible hose, having at least one holding area for the at least axial holding of the hose and with at least one one-sided support area surrounding the hose and extending towards the free end.

2. Device according to claim 1, wherein the holding area has inwardly directed annular ribs.

3. Device according to claim 1, further comprising an application area for applying the device to a holding part.

4. Device according to claim 3, wherein the holding part is constructed as a fixing clamp or clip.

5. Device according to claim 3, wherein the application section has an outer annular groove.

6. Device according to claim 5, wherein an inwardly directed lug of the holding part engages in the annular groove.

7. Device according to claim 1, further comprising an a construction with at least two partial shells (half-shells).

8. Device according to claim 7, wherein the partial shells are screwed together.

9. Device according to claim 7, wherein the partial shells are interconnected by snap action devices.

10. Device according to claim 7, wherein the partial shells are held together by a closing ring.

11. Device according to claim 10, wherein the closing ring is constructed in one piece.

12. Device according to claim 10, wherein the closing ring is formed by several partial rings.

13. Device according to claim 12, wherein the partial rings of the closing ring are connectable by snap constructions by snapping in perpendicular to the axis of symmetry.

14. Device according to claim 12, further comprising rigid, complimentary shapes, engaging behind in the closed position and located on end faces of the partial rings of the closing ring and axial connectability of the shapes and therefore the partial rings.

15. Device according to claim 10, further comprising a cylindrical shoulder for the non-positive reception of the closing ring in a radial and circumferential direction.

16. Device according to claim 1, wherein the support area has a trumpet-shaped extension.
